(19) United States
(12) Patent Application Publication
(10) Pub. No.: US 2009/0061843 A1
(43) Pub. Date: Mar. 5, 2009

(54) System and Method for Measuring the Speech Quality of Telephone Devices in the Presence of Noise

(76) Inventor: Dimitrios M. Topaltzas, Ellicott City, MD (US)

Correspondence Address: CAPITAL LEGAL GROUP, LLC, 1100 River Bay Road, Annapolis, MD, 21409, US

(21) Appl. No.: 11/846,198

(22) Filed: Aug. 28, 2007

(51) Int. Cl. H04Q 7/20

(52) U.S. Cl. 455/423

(57) ABSTRACT

A system and method for measuring speech quality of a mobile telephone device in the presence of noise is provided. In one embodiment the method may comprise determining a test speech volume, which that comprises the speech volume that results in the best speech quality provided by the telephone device when the telephone device is not in the presence of noise. Subsequently, the method may include audibly producing test speech having a volume substantially equal to the test speech volume for reception by the telephone device, concurrently with audibly producing test speech, supplying audible noise to the telephone device, receiving a signal that includes the test speech and noise communicated from the telephone device; and determining a speech quality for the received signal. The method may be repeated for numerous telephone devices, including handsets and telephone accessory devices, under different noise conditions, and/or for different communication networks.

### FIELD OF THE INVENTION

The present invention generally relates to systems and methods for evaluating communication devices, and more particularly to systems and methods for measuring the speech quality provided by a mobile telephone device in the presence of noise.

### BACKGROUND OF THE INVENTION

Mobile telephone devices have become ubiquitous in our society. Unlike conventional landline telephones, which typically operate in a home, office, or other relatively quiet environment, mobile telephone devices are often used while the user is in a noisy environment. One challenge to those designing mobile telephone devices is to design the telephone devices to provide the desired speech quality (as received by a remote landline-listener) even when the user is using the telephone device in a noisy environment. Further, wireless network operators also want users of their network to use telephone devices that provide adequate speech quality in the presence of noise to ensure that the user has a satisfactory experience using the wireless network. Thus, there are numerous parties who desire to test the quality of speech provided by a mobile telephone device in the presence of noise.

There are, however, a wide variety of telephone devices used for communication over wireless mobile telephone networks. As used herein, the phase “telephone devices” is meant to include mobile telephones and associated accessory communication devices that operate with a mobile telephone such as, for example, wired and wireless headsets and earpieces that include a microphone or other audio input mechanism. With the proliferation of mobile telephone devices, many styles of telephones and accessories have evolved. Different models and styles result in different positioning of the audio input mechanism (e.g., microphone) relative to the user's mouth. The different designs of telephone devices result in different performance characteristics for each telephone device. Various design characteristics may impact the quality of the speech provided by a telephone device and its susceptibility to being negatively impacted in the presence of noise (i.e., impact its noise suppression characteristics). For example, the physical structure of the telephone device, which drives, in part, the positioning of the microphone relative to the user's mouth during normal operation, is one factor that impacts the quality of the speech provided by a telephone device. Another factor may be the type, size, orientation, and/or accompanying circuitry of the microphone of a telephone device. As a result, the many different mobile telephone devices, including mobile telephones and associated accessories such as headsets and earpieces, have varying performance characteristics due to there design. Thus, different telephone devices operating in an environment with the same noise will often provide different speech quality.

One of the challenges of measuring speech quality under noise conditions for telephone devices is to objectively compare the speech quality of such device in the presence of noise even though the physical designs are different. Thus, the present invention provides methods and systems to objectively measure speech quality of telephone devices in noise conditions and to establish performance standards for speech quality. For example, various embodiments of the present invention provide methods and systems for measuring the speech quality experienced by a landline-listener (or other remote device) in communication with a caller speaking into a telephone device while in the presence of noise. Various embodiments of the present invention provide these and other advantages.

### SUMMARY OF THE INVENTION

The present invention provides a system and method for measuring speech quality of a mobile telephone device in the presence of noise is provided. In one embodiment the method may comprise determining a test speech volume, which that comprises the speech volume that results in the best speech quality provided by the telephone device when the telephone device is not in the presence of noise. Subsequently, the method may include audibly producing test speech having a volume substantially equal to the test speech volume for reception by the telephone device, concurrently with audibly producing test speech, supplying audible noise to the telephone device, receiving a communication signal that includes the test speech and noise communicated from the telephone device at the test device; and determining a speech quality for the received communication signal. The method may be repeated for numerous telephone devices, including handsets and telephone accessory devices, under different noise conditions, and/or for different communication networks.

The invention will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram of an example speech quality test environment for measuring speech quality according to an example embodiment of the present invention;

FIGS. 2a-b are diagrams of a portion of other example speech quality test environments for measuring speech quality according to an example embodiment of the present invention; and

FIG. 3 illustrates an example method for measuring speech quality in noise conditions according to an example embodiment of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, telephone devices, mobile telephones, accessory devices, simulators, ear pieces, headsets, telephone handsets, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, telephone devices, mobile telephones, accessory devices, simulators, ear pieces, headsets, telephone handsets, terminals, devices, components, techniques, data and network protocols, software products and systems, development interfaces, operating systems, and hardware are omitted so as not to obscure the description of the present invention.

According to an embodiment of the present invention, the speech quality provided by a mobile telephone device, such as mobile telephone, is measured. As used herein, “mobile telephone” means a telephone configured to communicate over a wireless mobile telephone network. Other telephone devices include mobile telephone accessories (e.g., a wired or wireless) such as an earpiece, headset, speaker phone (e.g., that includes a microphone and which may be, for example, in an automobile, or other device), or other such device. A mobile telephone, also sometimes commonly referred to as a cell telephone, is a long-range, mobile electronic device used for mobile communications. In addition to providing the standard voice function of a telephone, many mobile telephones may support additional services such as SMS for text messaging, email, packet switching for access to the Internet, and MMS for sending and receiving photos and video. A conventional mobile telephone may wirelessly communicate via a cellular network of base stations (cell sites), which is connected to the public switched telephone network (PSTN).

As is known in the art, speech quality may be determined by analyzing the received speech via suitable algorithms to determine a mean opinion score (MOS). The present invention may be used to determine the speech quality experienced by a landline listener in communication with a caller speaking into the subject telephone device while the caller is in the presence of noise such as, for example, street noise. When testing speech quality across multiple mobile telephone devices and/or among differing conditions, it is desirable to have a consistent ratio of “speech signal”-to-“noise” ratio for proper comparison of test results. A mobile telephone device also may be integrated into an automobile (i.e., a car phone). In addition, a mobile telephone device, itself,

According to one example embodiment of the present invention, prior to the application of noise, the speech signal level (i.e., the volume or power) output from a speech producing test device and into a mobile telephone device being tested is adjusted to a level that achieves substantially the greatest (optimal) speech quality as received by a landline listener. The speech quality received may be determined by analyzing the received speech to determine the MOS, and adjusting the output from the test equipment until the highest MOS is achieved. This output from the test equipment provides the best (e.g., optimal) speech quality without application of noise. While using the speech output volume from the test equipment that provides the highest means score, noise is applied and the speech quality measured for various noise conditions (e.g., different noises and/or volumes of noise) to provide a reliable speech quality measurement in the presence of noise.

One might first conclude that, in order to provide objective test results, the test equipment should produce test speech having the same volume for each telephone device being tested. However, this testing procedure may lead to erroneous results in some instances. For example, using the same output volume from the test equipment may give those devices having a microphone that is physically closer to the mouthpiece of the test equipment an unwarranted better speech quality score than other devices. One reason for this is that in the presence of noise the user may speak slightly louder and/or move the microphone of the telephone device slightly closer to the user's mouth to ensure better speech quality is provided to the listener on the remote telephone. While such a test process may be suitable in some circumstances (e.g., when the telephone devices are all similar in structure and/or circuitry), it is not a preferred embodiment of the present invention.

### Speech Quality Test Environment

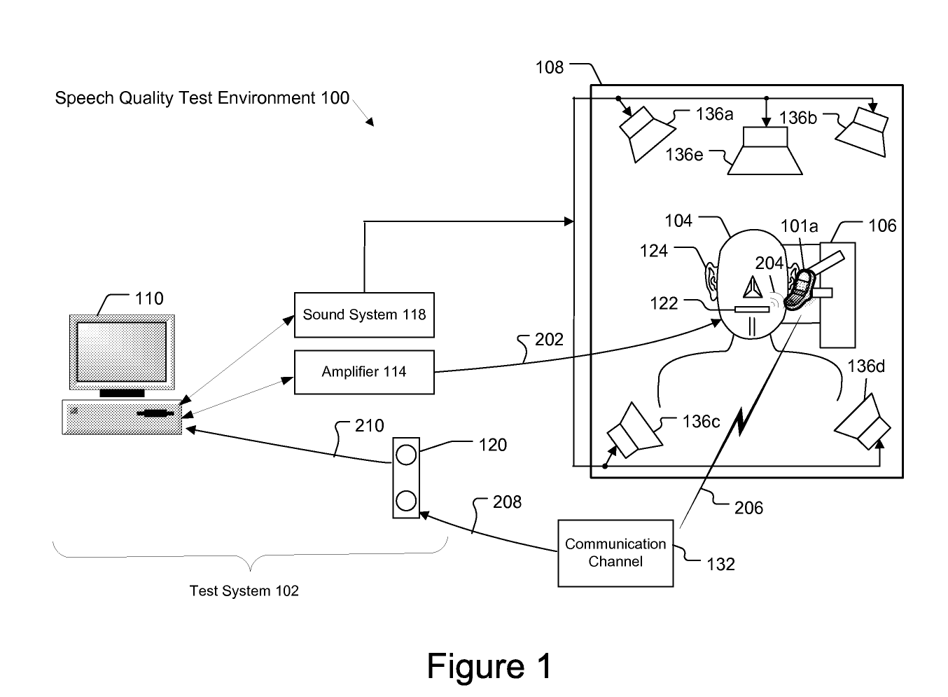

FIG. 1 shows an example embodiment of a speech quality test environment 100 for measuring speech quality provided a mobile telephone device 101a. This test environment 100 includes a test system 102 and a head and torso simulator (HATS) 104, which may be positioned near the center of a sound room 108.

The HATS 104 is a mannequin-like structure with a built in mouth simulator 122 and a mounting device 106 that is used to position and hold the telephone device 101a being tested in place. In some embodiments the HATS 104 also may include one or more built in ear simulators 124, and may have an adjustable neck which allows for testing in various postural positions. The HATS 104 is used to provide a realistic reproduction of the acoustic properties of an average adult human head and torso.

In example embodiment the mouth simulator 122 includes a high-compliance loudspeaker with a low-frequency response and low distortion and may provide for discreet audio level settings. The mouth simulator 122 may produce a sound-pressure distribution around the opening of the mouth which simulates that of a median adult human mouth. The position of the acoustic center of the mouth simulator 122 also may follow that of human subjects over the speech frequency range. Speech into the telephone device 101a via the mouth simulator 122 of the HATS 104 may be accomplished in a manner consistent with ITU-T P.51 and ITU-T P.57. Various example of HATS that are available commercially such as those available from Brüel & Kjær having its headquarters at Skodsborgvej 307, DK-2850 Nærum-Denmark.

The mounting device 106 allows for accurate and repeatable positioning of a mobile telephone device 101 a that is to undergo testing in the speech quality test environment 100. The mounting device 106 may include a mounting bracket allowing the testing of variously designed mobile telephone devices. For example, mobile telephones, ear pieces and headsets, with or without antenna, and with symmetrically or asymmetrically mounted transducers may be mounted. Further, the same devices with wired or wireless interfaces may be accommodated. The mounting device 106 may allow for testing with the mobile telephone device 101 a positioned among various standardized or customized positions. The mobile telephone device 101a may be spring-loaded against the ear with an adjustable ear force. In some embodiments the device may be positioned on either ear. If an accessory device is to be tested, the device may be mounted on the ear pinna of the HATS 104.

As illustrated in FIG. 1, the test system 102 may include a communications quality analysis (CQA) controller 110, an audio amplifier 114, and a speech receiving device 120 such as a telephone or other device. The CQA controller 110 is used to operate and control the test system 102 to provide the speech quality measurements. Specifically, the controller 110 may comprise a computer system (which may be a portable computer) having a memory (or access to memory) that stores computer program code and a plurality of data files. The data files may include, for example, noise files (e.g., digital files of binaurally recorded noise), test speech files, received speech files, test results, and/or other data files. The program code may include algorithms for performing analysis of received (and recorded) speech to determine the quality of the received speech. Further, the program code may include one or more code segments for implementing one or more tests and for controlling other components of the test system 102, such as, for example, a segment for automating test procedures and an audio player for producing analog (or digital) signals from digital audio test speech files.

In addition, the controller 110 may include various software and hardware configured to implement features for efficient and effective measurement, system control, calibration, signal generation, recording, analysis, and data archival. In addition, the controller 110 may facilitate calibration of the test system 102 in dBV, dBm, dBSPL, dBPa and dBm0. Depending on the embodiment and test procedure(s), analyses may be performed in the time domain with determination of level, or in the frequency domain with determination of transfer function, distortion factor, rub and buzz, noise, correlation, impulse response, and loudness rating. Measurement parameters may be modified according the test procedure. Tolerance schemes may be created, modified, and automatically verified. Various acoustical sources (e.g. loudspeakers) may be linearized at a given point in space. In other embodiments the system 102 may include a speech input generator operatively connected to the controller 110. A suitable commercially available CQA controller, that includes a speech input generator, is available as the Advanced Communication Quality Analysis System from Head Acoustics, Inc., which is located in Brighton, Mich.

In this example, the controller 110 is communicatively coupled to an audio amplifier 114, which is in turn connected to the HATS 104. During testing, test speech files from the controller 110 are produced (e.g., played by an audio player software program) to provide analog electrical signals to the amplifier 114, which amplifies the received signals. The amplified signals are then supplied to the HATS 104 to be audibly produced by mouth simulator 122. The controller 110 may be used to control the amount of amplification provided by amplifier 114 or the amplifier 114 may be independently controlled such as by the operator. By controlling the amplification provided by amplifier 114, the output sound volume from the mouth simulator 122 of the HATS 104 is controlled. In some embodiments, the output volume of the mouth simulator 122 may be adjusted as well.

In this example, the controller 110 is also communicatively coupled to a sound system 118 (e.g., which may be stereo system), which in turn is connected to a speaker system that includes a plurality of speakers 136. In this embodiment, the HATS simulator 104 is disposed in the center of a sound room 108 that provides sufficient acoustic isolation to ensure that external sounds are not recorded in the audio samples. The speaker system, which may include one or more speakers 136 (e.g., four loudspeakers 136a-d and a sub-woofer 136e), is located within the sound room 108 for providing audible noise.

As discussed, the test system 102 may include one or more noise files that, when produced (e.g., played by an audio player software program), provide signals to the sound system 118, which provides audio signals to the speakers 136 to thereby provide audible noise for a given test. Various noises noise may be selected and produced to simulate the typical sounds a person may experience while using a mobile telephone device such as, for example, sounds experienced in a car, on a street, and sounds of other people talking. In one example embodiment, the noise simulation environment substantially complies with guidelines provided in TSI Guide 202 396-1. A diffuse noise field may be created to provide a meaningful repeatable noise environment for testing speech quality under controlled noise conditions. An alternate system may additionally include noise input generator. An commercially available suitable noise generator is available from Head Acoustics, Inc. referenced above.

Test procedures are performed under the control of the CQA controller 110. For example, recorded test speech may be produced (e.g., played by an audio player software program to produce audio signals) by the controller 110 and the analog speech signals provided to the amplifier 114. The amplifier 114 amplifiers the received speech signals and provides amplified speech signals to the HATS 108, which audibly outputs the test speech through mouth simulator 122. As discussed, the volume of the speech provided by the amplifier 114 may be adjusted and controlled by the CQA controller 110.

The test speech is audibly output from the mouth simulator 122 into the mobile telephone device 101a under test, and communicated back to the test system 102 via a communication channel 132. In one embodiment, communication channel 132 may comprise a base-station simulator (BTS), such as a GSM BTS simulator whereby the AMR full rate 12.2 CODEC is exercised. Various commercially available simulators may be used and various networks may be simulated according, for example, to the test procedure to be performed. While not illustrated in the figure, the controller 110 also may be in operative communication with the BTS to control the BTS settings (e.g., the type of network, CODEC settings, etc.). Alternately, the BTS may be independently controlled by test personnel. In this example, the handset 101a is communicatively coupled to the communication channel 132 (a BTS) via a wireless link 206, which may be accomplished via a radiated antenna. Alternately, the communication channel 132 may be connected to the handset 101a by way of a wired connection via an auxiliary antenna input of the handset 101a.

In an alternate embodiment, the communication channel 132 may comprise a local wireless mobile telephone network. More specifically, the handset 101a may communicate the test speech through the commercial mobile wireless network that services the geographical area where the sound room 108 is located. As will be evident to those skilled in the art, the communication channel 132 may be any network capable of carrying the communications. Exemplary communication channels 132 may comprise one, or some combination of the public switched telephone network, a wireless telecommunications network (such as those based on any of the following telecommunication standards: AMPS, D-AMPS, CDMA2000, GSM, GPRS, EV-DO, UMTS, G1, G1.5, G2, and G3), a broadband communication network, a VoIP network, and/or another wired or wireless network capable of communicating analog voice or digitized voice communications. The test procedures described herein may be performed on the same mobile telephone device 101a for various communication networks 132 (e.g., by changing the settings of the BTS).

The test system 102 may receive the speech communication at a receiving device 120 coupled to the communication channel 132. In this embodiment, the receiving device 120 may comprise a landline telephone that is connected to the communication channel 132 via link 208 and that is also connected to the controller 110 via link 210. Link 210 connecting the receiving device 210 to the controller 110 may be a wired link that conducts the analog signals representing the test speech to the controller 110 for storage and processing. In yet another embodiment, the controller 110 includes a receiving device and is connected to the channel 132 without the need for a separate receiving device 120. In another embodiment, the receiving device 210 may rest in a cradle so that the audible output from the receiving device 210 is received by an audio input device (e.g., microphone) integrated with or connected to the controller 110 (whereby link 210, therefore, includes an audible link through air).

Test speech may be received as an analog signal by controller 110 (e.g., from receiver device 210) and converted to a digital format for storage. The received speech is stored as a speech file in the memory of controller 110, and processed to provide a MOS. The recorded speech files thus contain the speech as supplied by the mobile telephone device 101a and subsequently degraded by the communication channel 132 and other communication links (e.g., 206, 208, 120, 210). As discussed, the processing may be performed by well known algorithms used to assess speech quality and/or provide a MOS. For example, the speech files may be processed to determine the speech quality according to a standard PESQ scoring (e.g., ITU-T P.862.1 scoring), or other scoring method. In addition, the speech files may be prepared for presentation to live listeners in accordance with ITU-T P.835 recommendation. For live listener scoring, each listener may be instructed to rate each of the speech signal, the background (e.g., noise), and the overall speech sample on a scale of 1 to 5.

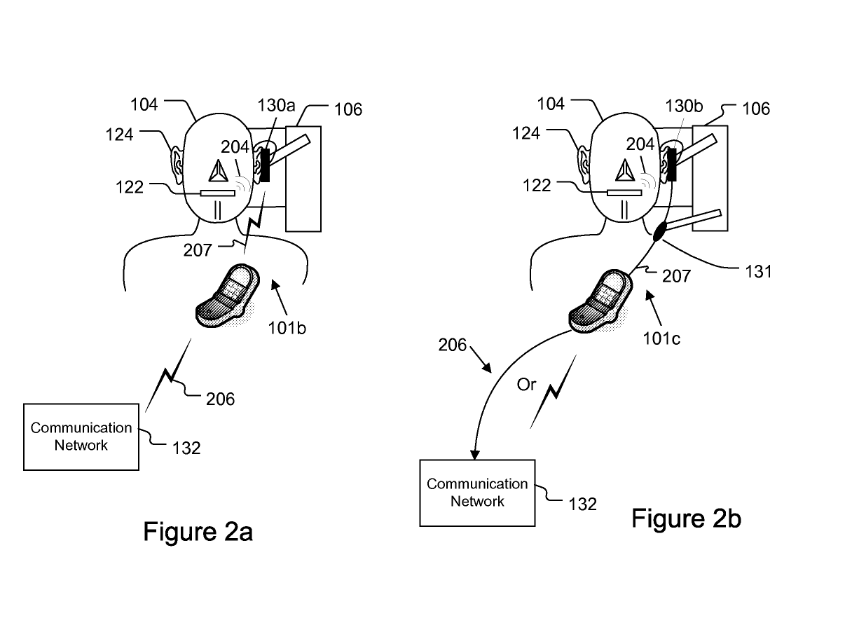

FIG. 2a shows an alternative embodiment of a portion of the test environment 100 in which a mobile telephone handset 101b is coupled to an accessory device 130a. Although not depicted, the HATS 104 of each figure (along with the mobile telephone handset 101 and accessory devices 130) may be positioned within a sound room as discussed with the test environment 100 of FIG. 1. In addition, although not depicted in FIGS. 2a-b, the communication channel 132 is coupled to the test system 102, in the same manner as shown for the mobile telephone device 101a of FIG. 1. In FIG. 2a, the mobile telephone handset 101b is coupled to a wireless earpiece 130a such as, for example via a Bluetooth® or other wireless link 207. The earpiece 130a may be mounted to the HATS 104 by the mounting device 106 or otherwise inserted into the ear pinna of the HATS 104, or otherwise by using the mounting mechanism of the ear piece (e.g., an ear clip, etc.). Thus, after mounting, the earpiece 130a generates an electrical speech signal in response to speech input produced by the mouth simulator 122 of the HATS 104. The electrical speech signal 207 is communicated to the mobile telephone handset 101b, such as by a wired or, in this example, a wireless interface. In turn, the telephone handset 101b generates a communication signal 206, which is then communicated to and through the communication channel 132.

FIG. 2b illustrates yet another configuration in which the mobile telephone handset 101c is connected to a wired earpiece. The microphone 131 (or other transducer) may be located in various positions, such as in the vicinity of the ear bud, along an arm protruding from the frame, or along a wire coupling the accessory device 130b to the mobile telephone handset 101c as illustrated in FIG. 2b.

In this example embodiment, the test system 102 is co-located (e.g., in the same building) as the sound room 108, HATS 104, and telephone device 101 under test. In other embodiments, the test system 102 may be remote (in a different building, county, city, state, or country) from the sound room 108, HATS 104, and telephone device 101 under test. In addition, various other test systems 102 and environments 100 may also be used to implement various embodiments of the present invention.

### Speech Quality Test Methods

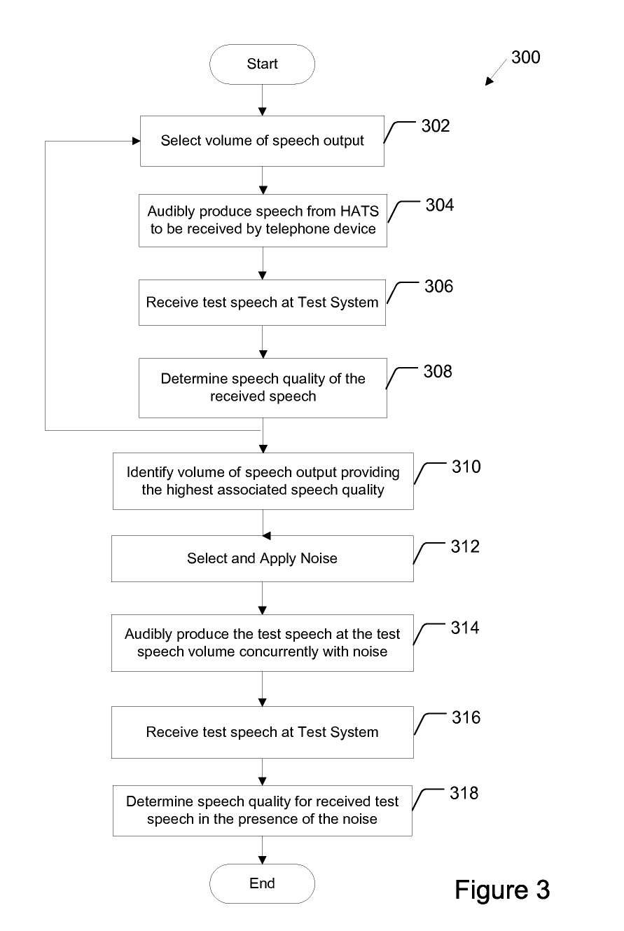

FIG. 3 illustrates an example process 300 for assessing the speech quality provided by a mobile telephone device 101 according to an example embodiment of the invention. Testing is performed for a given mobile telephone device 101 communicating with a remote device 120 via a communication channel 132. Testing may be performed for differing mobile telephone devices and/or for differing communication channels.

At steps 302-308, speech quality is determined for a plurality of speech outputs with each output having a differing volume level. In this example, steps 302-308 are performed under no noise conditions (i.e., the speakers 136 within the sound room 108 are silent). At step 302, a first volume for a first speech output is selected. As a result, the amplifier 114 may be adjusted to provide the selected volume. At step 304, the test speech is audibly produced from the mouth simulator 122 of the HATS 104 (after being amplified at the amplifier 114) for reception by the telephone device 101 (e.g., mobile telephone handset, earpiece, headset, etc.) under test. The telephone device in turn transmits a communication signal (representing the received test speech) via the communication channel 132 to the remote device 120, which provides the signal to the controller 110. At step 306, the signal representing the test speech is received by the controller 110, which may convert the analog signal to a digital signal (if necessary), and store the digital signal in memory.

At step 308 the speech quality of the received test speech 210 is determined, such as by scoring the speech via an algorithm that provides a PESQ standard core, another MOS scoring method, and/or live listener scoring. In other embodiments, the analysis may be standardized and conform to any of the various signal evaluation standards, such as the TIA/EIA standards in North America or the ETSI, VDA, and FTZ standards in Europe.

In this embodiment, steps 304-308 are repeated a plurality of times (e.g., 3, 4, 5, 10, 20, or more times) by selecting a different volume for the speech output (at step 302) each time in order to identify a speech volume that results in received speech (received at the controller 110) having the highest MOS or other score. In one example implementation, five samples of test speech are audibly produced from the mouth simulator 122 of the HATS 104 in the range of 75 dB to 85 dB. As will be evident to those skilled in the art, step 308 may be performed after all the test speech files are received and stored in memory and need not be performed before the subsequent speech output.

At step 310 the volume of speech output that results in the best received speech quality (referred to herein as the test speech volume) is identified by comparing the speech quality resulting from each of the plurality of volumes of speech output and selecting the volume for the speech output that provides the highest quality of speech (e.g., the highest MOS). Information of the identified test speech volume is stored by the controller 110 in memory.

It is worth noting that in some instances, two or more different volumes of speech output may result in the same, or substantially the same, speech quality. In such instances, selection of the volume of speech output may be arbitrary or performed according to secondary criteria such as, for example, by selecting the highest volume, the lowest volume, the volume nearest a predetermined volume level, and/or other criteria. In some embodiments it may be desirable to identify the speech output volume that provides the absolute optimal or best speech quality, but it may not be possible or practical in all instances to do so. More specifically, some embodiments of the present invention are used to identify the speech output volume that provides the best speech quality relative to other volumes of speech output that are tested, but that might not provide a better speech quality than some speech output volumes for which the speech quality is not tested.

At step 312, the controller 110 selects, retrieves from memory, and applies the selected noise via the sound system 118. Specifically, the noise is audibly produced via the speakers 136 located in the sound room 108. As discussed, various noises (stored as noise files in the memory of the controller 110) may be used and may include those provided in the ETSI database such as, for example, car noise (stationary), babble noise (non-stationary), and/or street noise (non-stationary).

At step 314, the process 300 includes audibly producing the test speech at the test speech volume (i.e., the volume of speech identified at step 310 as providing the best speech quality) concurrently with audible production of the noise. In one embodiment, the controller 110 controls the amplification of the amplifier 114 to set the output speech volume (produced by the HATS 104) to be substantially equal to the test speech volume. The controller 110 may then retrieve the test speech file, generate analog signals representing the test speech from the speech file (e.g., play the speech file to provide an analog signal) and supply the analog test speech signal to the amplifier 114, which amplifies the speech signal and supplies the amplified speech signal to the HATS 104 for audible production by the mouth simulator 122.

The audio waves from both the mouth simulator 122 (the test speech) and the speakers 136 (the noise) impinge on the telephone device 101 transducer and ultimately are converted into the communication signal 206. The mobile telephone device 101 transmits the communication signal 206 via the communication channel 132 to the remote device 120. The receiving device 120 receives the communication signal and provides it to the controller 110, which receives the signal at step 316.

At step 318, the process 300 concludes by determining the speech quality for the telephone device in the presence of noise. For example, the determination process may be accomplished in the same as described for step 308 via processing by controller 110 to provide a MOS and/or via using live listeners. Thus, the best identified quality speech quality volume (under no noise conditions) is used to evaluate speech under one or more prescribed noise conditions. The process 300 may be repeated for a plurality of mobile telephone devices 101 to allow a device manufacturer (or designer) to compare the scores of the plurality of devices in order to select the better performing devices/designs for production. Similarly, the process 300 also may be used (or required or referenced) by wireless network operators to test a plurality of mobile telephone devices 101 to ensure telephone devices meet minimum speech quality scores before they are permitted to be used with the operator's wireless network. Thus, one or more speech quality scores (or data based thereon such as an average score) of a telephone device may be compared to one or more threshold scores (i.e., a minimum score for telephone devices permitted to work with a particular wireless network) to determine if a telephone device has passed or failed a speech performance test associated with a particular network.

In some embodiments steps 312-318 may be repeated for differing noise input conditions (e.g., noise volume) and/or noise files. In particular a noise suppression profile may be generated for a given handset, (e.g., using the same test speech volume) based on the speech quality determined for each of a plurality of noises. The noise suppression profile may be used as a metric for rating mobile telephone devices and for comparing the mobile telephone devices with other mobile telephone devices. The process 300 also may be repeated for various communication networks 132 (by changing the settings of a BTS that is acting as the communication channel 132 or by changing the location of the sound room to test a different live network that is acting as the communication channel 132) to determine how well a mobile telephone device performs in different communication networks.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, steps and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method for measuring speech quality of a mobile telephone device in the presence of noise, comprising:
determining a test speech volume that comprises a speech volume that results in the best speech quality for audible speech received by the telephone device and communicated to a device;
audibly producing test speech having a volume substantially equal to the test speech volume for reception by the telephone device;
concurrently with audibly producing test speech, supplying audible noise to the telephone device;
receiving a communication signal that comprises the test speech and noise communicated from the telephone device; and
determining a speech quality for the received communication signal.

2. The method of claim 1, wherein determining a test speech volume comprises audibly producing test speech for reception by the telephone device at a plurality of speech volumes.

3. The method of claim 1, wherein the communication signals is communicated from the telephone device through a base station simulator.

4. The method of claim 1, wherein the mobile telephone device comprises a wireless earpiece communicatively coupled to a mobile telephone handset.

5. The method of claim 1, wherein said audibly producing test speech, said supplying audible noise, said receiving the communication signal, and said determining a speech quality are performed a plurality of times using a different noise each time.

6. The method of claim 1, further comprising storing the received communication signal in a memory, and wherein said determining a speech quality comprises executing program code configured to determine the speech quality by providing a mean opinion score.

7. The method of claim 1, further comprising storing the received communication signal in a memory, and wherein said determining a speech quality comprises audibly producing the speech and noise to a live listener.

8. A method for measuring speech quality of a telephone device in the presence of noise, comprising:
selecting a speech volume based on an associated speech quality provided by the telephone device for the selected speech volume without application of noise;
audibly producing test speech having a volume substantially equal to the selected speech volume;
concurrently with audibly producing test speech, audibly producing noise for reception by the telephone device;
receiving a communication signal communicated from the telephone device that represents the test speech produced during audible production of the noise; and
determining a speech quality for the received communication signal.

9. The method of claim 8, further comprising storing the received communication signal in a memory, and wherein said determining a speech quality comprises executing program code configured to determine the speech quality by providing a mean opinion score.

10. The method of claim 8, wherein the communication signals is communicated from the telephone device through a base station simulator.

11. The method of claim 8, wherein the mobile telephone device comprises a wireless earpiece communicatively coupled to a mobile telephone handset.

12. The method of claim 8, wherein said audibly producing test speech, said supplying audible noise, said receiving the communication signal, and said determining a speech quality are performed a plurality of times using a different noise each time.

13. The method of claim 8, further comprising storing the received communication signal in a memory, and wherein said determining a speech quality comprises audibly producing the speech and noise to a live listener.

14. The method of claim 8, further comprising:
selecting a noise file; and
executing an audio player to create an analog signal representative of the noise file.

15. A method for measuring speech quality of a telephone device in the presence of noise, comprising:
mounting a telephone device to a test device configured to provide speech output to the telephone device;
performing steps a-c using a different volume level to obtain a plurality of speech qualities;
a. audibly producing test speech from the test device to the telephone device having a volume level;
b. receiving the test speech at a remote device; and
c. determining a speech quality for the received test speech;
identifying a test speech volume by determining which of the plurality of volumes of test speech resulted in the best speech quality;
audibly producing test speech from the test device for reception by the telephone device at the test speech volume and concurrently audibly producing noise;
receiving the test speech at a remote device; and
determining a speech quality for the received test speech.

16. The method of claim 15, further comprising storing the received communication signal in a memory, and wherein said determining a speech quality comprises executing program code configured to determine the speech quality by providing a mean opinion score.

17. The method of claim 15, further comprising storing the received communication signal in a memory, and wherein said determining a speech quality comprises audibly producing the speech and noise to a live listener.

18. A method for measuring speech quality of a mobile telephone device in the presence of noise, comprising:
audibly producing test speech for reception by the telephone device at a plurality of speech volumes without application of noise;
determining a speech quality score for the test speech at each of the plurality of volumes;
selecting a speech volume that results in the best speech quality score;
audibly producing test speech having a volume substantially equal to the selected speech volume for reception by the telephone device;
concurrently with audibly producing test speech, supplying audible noise to the telephone device;
receiving a communication signal communicated from the telephone device that represents the test speech produced during audible production of the noise; and
determining a speech quality for the received communication signal.

19. The method of claim 18, wherein the communication signals is communicated from the telephone device through a base station simulator.

20. The method of claim 18, wherein the mobile telephone device comprises a wireless earpiece communicatively coupled to a mobile telephone handset.

21. The method of claim 18, wherein said audibly producing test speech, said supplying audible noise, said receiving the communication signal, and said determining a speech quality are performed a plurality of times using a different noise each time.

22. The method of claim 18, further comprising storing the received communication signal in a memory, and wherein said determining a speech quality comprises executing program code configured to determine the speech quality by providing a mean opinion score.

23. The method of claim 1, further comprising storing the received communication signal in a memory, and wherein said determining a speech quality comprises audibly producing the speech and noise to a live listener.

24. A method for measuring speech quality of a telephone device in the presence of noise, comprising:
providing a test device configured to provide speech output to the telephone device disposed in a sound room;
providing a sound system configured to produce noise in the sound room;
mounting a telephone device to the test device;
audibly producing test speech for reception by the telephone device at a plurality of speech volumes without application of noise;
determining a speech quality score for the test speech at each of the plurality of volumes;
selecting a speech volume that results in the best speech quality score;
audibly producing noise via the sound system;
concurrently with producing the noise, audibly producing test speech having a volume substantially equal to the selected speech volume for reception by the telephone device;
receiving the test speech from the telephone device at a remote device; and
determining a speech quality for the received test speech.

25. The method of claim 24, wherein the test speech is communicated from the telephone device through a base station simulator.
